(19) United States
(12) Patent Application Publication
(10) Pub. No.: US 2025/0314894 A1
(43) Pub. Date: Oct. 9, 2025

(54) ROLLER BEARINGS FOR ELECTRONIC DEVICES

(71) Applicant: Apple Inc., Cupertino, CA (US)

(72) Inventors: Matin Seadat Beheshti, Sunnyvale, CA (US); Ivan S Maric, Campbell, CA (US)

(21) Appl. No.: 18/865,792

(22) PCT Filed: Jun. 1, 2023
(86) PCT No.: PCT/US2023/024189

§ 371 Date: Nov. 14, 2024

Related U.S. Application Data
(60) Provisional application No. 63/365,753, filed on Jun. 2, 2022.

(51) Int. Cl. G02B 27/01; G02B 7/00

(52) U.S. Cl. CPC G02B 27/0176; G02B 7/004

(57) ABSTRACT

A head-mountable display includes a first portion having a display and a second portion slidably engaged with the first portion via an adjustment mechanism. The adjustment mechanism can include a bore defined by the first portion or the second portion, a rod extending in the bore, a roller bearing, and a biasing member directly contacting the roller bearing.

### CROSS-REFERENCE TO RELATED APPLICATION(S)

This application is a National Stage filing based off of PCT Application No. PCT/US2023/024189, filed 1 Jun. 2023, and entitled “ROLLER BEARINGS FOR ELECTRONIC DEVICES” which claims priority to U.S. Provisional Patent Application No. 63/365,753, filed 2 Jun. 2022, and entitled “ROLLER BEARINGS FOR ELECTRONIC DEVICES,” the entire disclosure of which is hereby incorporated by reference.

### FIELD

The described embodiments relate generally to wearable electronic devices. More particularly, the present embodiments relate to adjustment mechanisms, devices, and systems for wearable electronic devices.

### BACKGROUND

Recent advances in portable computing have enabled head-mountable devices that provide augmented and virtual reality (AR/VR) experiences to users. Various components of these devices, such as displays, viewing frames, lenses, batteries, motors, speakers, and other components, operate together to provide an immersive experience. These components work together to contribute to the overall user experience. A user, upon donning a head-mountable device, may need to make adjustments to customize their experience, such as adjusting straps, viewing frames, lens width, screen brightness, or speaker volume so that individual user needs are met. Adjustments to the viewing frame and lenses can be particularly important, since these adjustments affect the visual quality and content of the device as experienced by the user.

Because each user is unique, a variety of adjustments to a head-mountable device may be needed to accommodate the user's individual needs. Some devices may only provide a limited number of adjustments, which in the case of viewing visual content, can distort an image, preventing a user from having an optimal immersive experience. In addition, variations of a single device to accommodate individual users can require a manufacturer to spend added time and money to produce multiple stock keeping units (SKUs) of a single product to accommodate user needs.

Therefore, what is needed in the art are devices and systems capable of providing continuous adjustments for head-mountable devices to meet the individual needs of the user.

### SUMMARY

In at least one example of the present disclosure, a head-mountable display includes a first portion having a display and a second portion slidably engaged with the first portion via an adjustment mechanism. The adjustment mechanism can include a bore defined by the first portion or the second portion, a rod extending in the bore, a roller bearing, and a biasing member directly contacting the roller bearing.

In one example, the roller bearing is a first roller bearing, the adjustment mechanism further includes a second roller bearing and a third roller bearing, and the first roller bearing, the second roller bearing, and the third roller bearing constrain a movement of the rod to one degree of freedom. In one example, the biasing member includes an elastic band. In one example, the elastic band includes silicone. In one example, the elastic band defines the bore. In one example, the biasing member includes a flexure arm having a first end and a second end, the first end anchored to the first or second portion defining the bore and the second end coupled to the roller bearing. In one example, the display is a first display, the second portion includes a second display, and the adjustment mechanism is configured to alter a distance between the first display and the second display.

In at least one example of the present disclosure, an adjustment mechanism for a head-mountable device includes a bore defined by a first portion, the first portion including a first display, a rod extending from a second portion and into the bore, the second portion including a second display, a bearing disposed against the rod, and a biasing member contacting the bearing.

In one example, the first display includes a first pupillary alignment point and the second display includes a second pupillary alignment point. In one example, sliding the rod relative to the bore alters a distance between the first pupillary alignment point and the second pupillary alignment point. In one example, the biasing member pushes the bearing toward the rod. In one example, the biasing member is anchored to the first portion. In one example, the biasing member includes an elastically stretched material disposed around the rod and the bearing, the bearing disposed between the biasing member and the rod. In one example, the biasing member includes a set screw having a terminal surface contacting the bearing. In one example, the set screw includes elastic material.

In one example of the present disclosure, a rod bearing assembly includes a first portion defining a bore, a rod extending into the bore, a roller bearing, and a biasing member directly contacting the roller bearing and pushing the roller bearing toward the rod.

In one example, the roller bearing is a first bearing, the rod bearing assembly includes a second bearing, and the biasing member directly contacts the second bearing. In one example, the biasing member includes an elastic band or sheath. In one example, the biasing member elastically deforms and is disposed around the rod, the roller bearings are positioned between the biasing member and the rod, the biasing member pushes the first bearing against the rod in a first direction normal to an outer surface of the rod, and the biasing member pushes the second bearing against the rod in a second direction different than the first direction and normal to the outer surface of the rod.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 shows a top view of a user donning an example of a head-mountable device;

FIG. 2 shows a side perspective view of an example of a head-mountable device;

FIG. 3 shows a rear view of an example of a head-mountable device;

FIG. 4 shows a top view of an example of a display portion of a head-mountable device;

FIG. 5 shows an example of a display portion of a head-mountable device including an adjustment mechanism;

FIG. 6A shows a perspective view of a portion of an adjustment mechanism including a rod and bearings;

FIG. 6B shows a cross-sectional view thereof;

FIG. 7 shows an example of an adjustment mechanism including biasing members;

FIG. 8 shows another example of an adjustment mechanism including a biasing member;

FIG. 9 shows another example of an adjustment mechanism including biasing members;

FIG. 10 shows an example of a biasing member contacting a bearing;

FIG. 11 shows another example of a biasing member contacting a bearing; and

FIG. 12 shows another example of an adjustment mechanism including a biasing assembly.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

The following disclosure relates to wearable electronic devices. More particularly, the present embodiments relate to adjustment mechanisms, devices, and systems for wearable electronic devices that are simple, require less parts than conventional adjustment mechanisms, and which can be easily, precisely, and accurately adjusted by the user, retailer, or manufacturer without the need for multiple SKUs. When donning wearable electronic devices, including head-mountable AR/VR devices described herein, the positions of certain components of the device relative to certain features of the user can affect the quality of the user experience. One example includes the positions of one or more displays of a head-mountable device relative to the user's eyes. Each user may have a different inter-pupillary distance (IPD), preferred focal length, and/or visual prescription affecting the optimal placement for the display or intermediately positioned optical lenses. To keep the visual outputs sharp and focused, such components need to be positioned within tight dimensional tolerances relative to the user. Facial anatomical variations between users complicates this issue of correctly positioning these components.

Along these lines, the adjustment mechanisms for electronic devices described herein can be manufactured using a minimal number of SKUs, or in some cases a single SKU, while enabling user-specific adjustments to customize the placement of displays, lenses, and other components of head-mountable electronic devices. The adjustment mechanisms can enable users to easily self-adjust components or manufacturers and retailers to adjust components as needed without affecting the proper functioning of the device. In at least one example, the adjustment mechanisms can include bearing assemblies, including friction bearing assemblies and systems. In one example a friction bearing assembly can be part of an inter-pupillary distance (IPD) adjustment mechanism on a head-mountable device used to provide AR/VR experiences to users. In another example, the friction bearing assembly can be part of an adjustment mechanism for altering a distance between one or more displays of a head-mountable device (e.g., an AR/VR device) and one or more lenses disposed between the display and the eye of the user. In another example, a friction bearing assembly can be part an adjustment mechanism used to keep outward facing cameras in alignment with the IPD adjustment system. However, the devices and systems described herein are not limited to the head-mountable devices. For example, friction bearing systems can be used in other applications where continuous frictional resistance may be needed such as other wearable electronic devices. Other devices can include wrist watches, arm bands, medical devices or other devices worn by a user.

In one example, a head-mountable display can be adjusted to accommodate the IPD of different users by using a roller bearing system. This is accomplished by joining the two viewing frames with a slidably connected rod surrounded by bearings, which can be cylindrical, conical, tapered, or other geometries, fit into a bore or hole. The bearings can have compressive forces applied inwardly toward the rod center by a biasing member. The biasing member can be a screw, elastic material, spring, or other means of compression. Similarly, another example of the roller bearing system can be used to alter the distance between the head-mountable display viewing lens and display lens. In yet another example, the display can be manipulated by use of the roller bearing system to accommodate the IPD of users.

In any case, the biasing member pushing the roller bearings against the rod provide constant contact between the bearings and the rod as the user manipulates the adjustment mechanism. During manipulation and after adjustments have been made, the constant contact between the roller bearings and the rod, due to the force from the biasing member on the roller bearings, can minimize or eliminate slop in the system due to space between the rod and bore being greater than the rod bearing. In this way, the adjusted device remains in the precise position during use. This can be accomplished by the biasing member directly contacting the bearing without the need for permanently pre-loading the bearings, which can cause the bearings to wear and increase friction in the system beyond what may be acceptable.

In addition, the force from the biasing member on the roller bearings can determine the friction between the rod and the bearings, and thus friction between the two portions of the device being adjusted relative to one another, by increasing or decreasing the normal force between the bearings and rod. The biasing member can apply a force directly on the bearings that balances the need for friction sufficient to prevent slipping of the adjusted component during use but also small enough to allow a person to self-adjust the mechanism.

In one example, a roller bearing system can include a rod, semi-rigid roller bearings, such that the durometer of the roller bearing provide elastic resistance when compressed, and a bore, wherein the rod and semi-rigid roller bearings are placed. The placement of the rod and semi-rigid roller bearings within the bore is such that the roller bearings are perpendicular to the rod and apply elastic force toward the rod's center due to compressive pressures created by the diameter of the bore hole. In this way, the rod, when actuated along its centerline axis, can be moved to any distance permitted by the rod and, when no axial force is applied, remain in the state at which it was actuated to without retracting or extending. The force which can produce actuation can be human generated, such as a user moving the unit with their hand, or machine generated, such as a motor.

In another example, a roller bearing system can include a rod, roller bearings, a bore, and a biasing member such as, but not limited to, a spring or set screw with a terminal surface contacting the bearing. The terminal surface can be the same material as the biasing member, coated, or a combination of materials, such as metal with a ceramic overlay which is in contact with the bearing. The biasing member can be adjusted in such a way that compressive force is applied to the roller bearings causing friction. The friction applied to the roller bearings can be sufficient to maintain the rod in a position to which it was actuated. These screws can be common to all devices made by the manufacturer and adjustable by the user or retailer at purchase to customize the fit of the device to the anatomical features of the user.

In one example, a roller bearing system can consist of a rod, more than one roller bearing, a biasing member, and a bore. The biasing member can be variably adjusted to increase or reduce friction. The variable adjustment manipulator can be a dial, a lever, a switch, a motor, or any other means of providing adjustments. The adjustment manipulator can be common among devices made by a manufacturer such that a single SKU of the electronic device, including the adjustment manipulator, can be fitted and customized to each user, either at the manufacturing stage, the retail stage, or the consumer use stage.

As a result, the devices described herein can provide a head-mountable device with additional advantages than previously available, such as an inter-pupillary distance range that is continuous and adjustable, which can better meet the individual needs of each user without the need for the manufacturer to produce multiple SKUs.

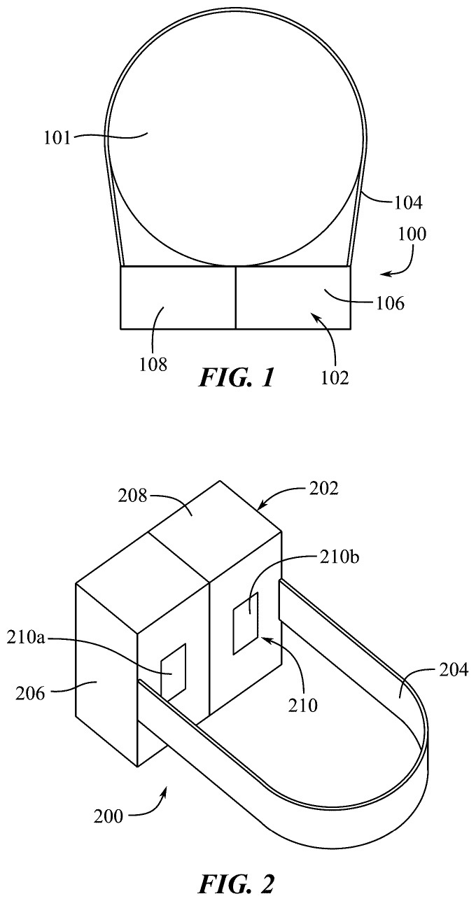

These and other embodiments are discussed below with reference to FIGS. 1-12. However, those skilled in the art will readily appreciate that the detailed description given herein with respect to these Figures is for explanatory purposes only and should not be construed as limiting. Furthermore, as used herein, a system, a method, an article, a component, a feature, or a sub-feature including at least one of a first option, a second option, or a third option should be understood as referring to a system, a method, an article, a component, a feature, or a sub-feature that can include one of each listed option (e.g., only one of the first option, only one of the second option, or only one of the third option), multiple of a single listed option (e.g., two or more of the first option), two options simultaneously (e.g., one of the first option and one of the second option), or combination thereof (e.g., two of the first option and one of the second option).

FIG. 1 illustrates a top view of an example of a wearable electronic device 100 donned by a user 101. The device 100 can include a display portion 102 secured to the user 101 via a securement strap 104. In at least one example, the display portion 102 can include multiple portions, components, or subcomponent, including first portion 106 and second portion 108, which can be adjustable in position relative to one another. In the illustrated example, the first and second portions 106, 108 can be left and right portions, respectively, of the display portion in general, including separate housing sections, each of which can include other components such as displays, speakers, processors, or any other component of the device 100.

In at least one example, the first portion 106 can be or include a first display and the second portion 108 can be or include a second display. The first and second portions 106, 108 can also include or be one or more other components of the device 100, including any two portions or components of a display portion 102 that need to be adjusted to fit the specific anatomical features of a user, as discussed above. In one example, the first portion 106 can generally refer to a display while the second portion 108 can generally refer to a lens disposed between the display and one or more eyes of the user 101. In one example, the first portion 106 can include a display and the second portion 108 can include an outward facing camera or other visual sensor.

While the display portion 102 is divide into two portions 106, 108 in FIG. 1, this is not meant as limiting. Rather, the separate first and second portions 106, 108 of the display portion 102 illustrated in FIG. 1 is shown to describe any two portions, components, or subcomponents of the device 100 capable of being positionally adjusted or changed relative to one or more other portions or components of the device 100 as described herein.

Any of the features, components, and/or parts, including the arrangements and configurations thereof shown in FIG. 1 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 1.

FIG. 2 illustrates a rear perspective view of an example of a wearable electronic device 200, which can be similar to the device 100 shown in FIG. 1 in that the device 200 in FIG. 2 includes a display portion 202 having a first portion 206 and a second portion 208 adjustable relative to one another and a securement strap 204 configured to secure the device 200 to a user. The device 200 shown in FIG. 2 can also include a first display 210a as part of the first portion 206 of the display portion 202 and a second display 210b as part of the second portion 208 of the display portion 202. The first and second displays 210a,b can be coupled with or a part of the first and second portions 206, 208 of the display portion 202, respectively, such that adjusting the position of the first or second portions 206, 208 of the display portion 202 adjusts the position of the first or second displays 210a,b, respectively.

In at least one example, the first display 210a can be configured to project light toward the left eye of a user and the second display can be configured to project light toward the right eye of the user when the user dons the device 200. As noted above, in order to provide focused images to the user from the displays 210a,b, the displays 210a,b can be adjustable via one or more mechanisms to customize the separation distance, angle, and depth of the displays 210a,b relative to the user's eyes.

In at least one example, the positions of the displays 210a,b can be independently adjusted relative to each other and relative to the first and second portions 206, 208 of the display portion 202 of the device 200. This can include an adjustment of the space separating the displays 210a,b from one another and the distance away from the user's eyes when donning the device 200. Additionally or alternatively, the displays 210a,b can be coupled to or a part of the first and second portions 206, 208 in such a way that an adjustment of the first or second portions 206, 208 relative to one another results in a corresponding adjustment of the first or second displays 210a,b.

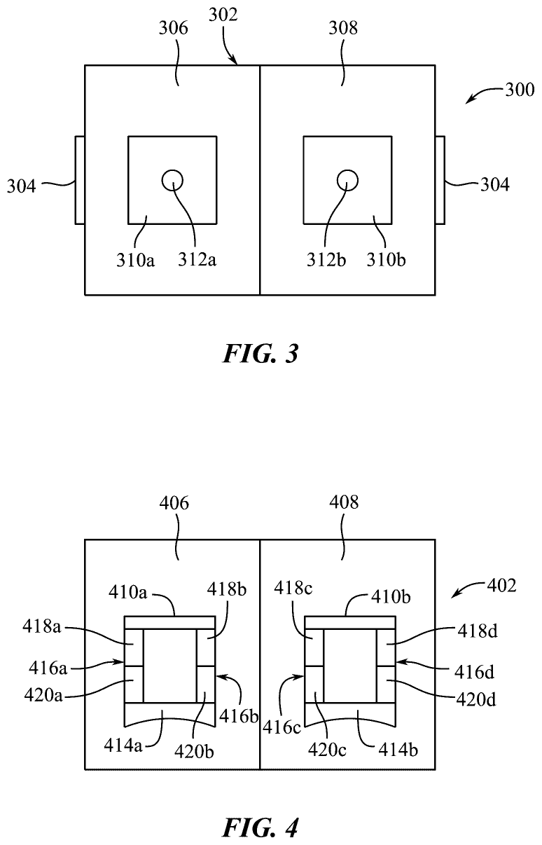

FIG. 3 illustrates a rear view of an example of a device 300 similar to the device 200 shown in FIG. 2, including a display portion 302 having first and second portions 306, 308 adjustable in position relative to one another. The first portion 306 includes a first display 310a and the second portion 308 includes a second display 310b. FIG. 3 also illustrates a first pupillary alignment point 312a of the first display 310a and a second pupillary alignment point 312b of the second display 310b. The pupillary alignment points 312a and 312b shown in FIG. 3 are not necessarily geometric center points of the displays 310a,b. Rather, the pupillary alignment points 312a,b represent a location of the screen meant to be visually aligned normal to or directly toward each eye of the user when the user dons the device 300 via the securement strap 304.

The device 300 can include an adjustment mechanism configured to adjust a distance between the pupillary alignment points 312a,b to match or accommodate the IPD of the user. The adjustment mechanism (not shown in FIG. 3 but described in more detail below with reference to other figures) can be configured to adjust the displays 310a,b independently of each other. Additionally or alternatively, the distance between the pupillary alignment points 312a,b can be altered via an adjustment to the first and second portions 306, 408 of the display portion 302 as the positions of the displays 310a,b can depend on the relative positions of the first and second portions 306, 308. The adjustment mechanism can be configured to be adjusted easily and precisely by the user or another person from the retail store selling the device 300 or from the manufacturer making the device 300.

Any of the features, components, and/or parts, including the arrangements and configurations thereof shown in FIGS. 2 and 3 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIGS. 2 and 3.

FIG. 4 illustrates a top view of a display portion 402 of a head-mountable device, including a first portion 406 and a second portion 408. The first portion 406 can include a first display 410a and the second portion 408 can include a second display 410b. The display portion 402 shown in FIG. 4 can be similar to those shown in other figures such that the first portion 406 and the second portion 408 are adjustable in position relative to one another via an adjustment mechanism (not shown) in order to adjust the relative positions of the displays 410a,b. In addition, the display portion 402 can include one or more other adjustment mechanisms configured to alter a distance between the first display 410a and a first lens 414a disposed between the user's left eye and the first display 410a when the display portion 402 is donned.

The first lens 414a can be configured to focus the images displayed by the first display 410a for the user. The first lens 414b can also accommodate a prescription of the user to focus the first display 410a during use. The display portion 402 can also include a second lens 414b disposed between the second display 410b and the user's right eye to serve the same or similar function as the first lens 414a with respect to the left eye of the user.

In at least one example, the display portion 402 can include one or more adjustment mechanisms 416a-d disposed between the lenses 414a,b and the displays 410a,b, respectively. Each adjustment mechanism 416a-d can include a first portion 418a-d and a second portion 420a-d, respectively, adjustable in position relative to one another. Adjusting the first and second portions 418a-d, 420a-d can alter a distance between the respective lenses 414a,b and displays 410a,b. The alteration of this distance between the lenses 414a,b and displays 410a,b, respectively, alters a focal distance of light produced by the displays 410a,b and passing through the lenses 414a,b to the user's eyes.

Each adjustment mechanism 416a-d shown in FIG. 4 and disposed between respective lenses 414a,b and displays 410a,b can similar such that the description of the first adjustment mechanism 416a can apply to other adjustment mechanisms 416b-d having like referenced portions 420b-d and 418b-d. In addition, each display 410a,b can have only one adjustment mechanism 416a-d disposed between the display 410a,b and its respective lens 414a,b. In at least one example, each display 410a,b can have more than two adjustment mechanisms 416a-d disposed between the display 410a,b and its respective lens 414a,b.

The first adjustment mechanism 416a can include a first portion 418a and a second portion 420a that are positionally adjustable relative to one another to alter a length of the adjustment mechanism 416a. The adjustment mechanism 416a is coupled at a first end to the display 410a and to the lens 414a at a second end. The length of the adjustment mechanism 416a can thus be altered in order to alter a distance between the display 410a and the lens 414a. As noted above, the description of the first adjustment mechanism 416a shown in FIG. 4 can also apply to the other adjustment mechanisms 416b-d shown in FIG. 4. In at least one example, the length of the second adjustment mechanism 416b, or the relative positions of the first and second portions 418a, 420a thereof, can be altered independently and different from of the first adjustment mechanism 416a such that the angle of the first display 410a is alterable.

Alternatively, the first and second adjustment mechanisms 416a,b are coupled to the first display 410a and lens 414a such that altering the length of one of the adjustment mechanisms 416a correspondingly alters the length of the second adjustment mechanism 416b. These same examples described with reference to the first and second adjustment mechanisms 414a,b can also be applied to the third and fourth adjustment mechanisms 414c,d shown in FIG. 4 such that the positions and angles of the first and second displays 410a,b can be adjusted as described.

Any of the features, components, and/or parts, including the arrangements and configurations thereof shown in FIG. 4 can be included, cither alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 4.

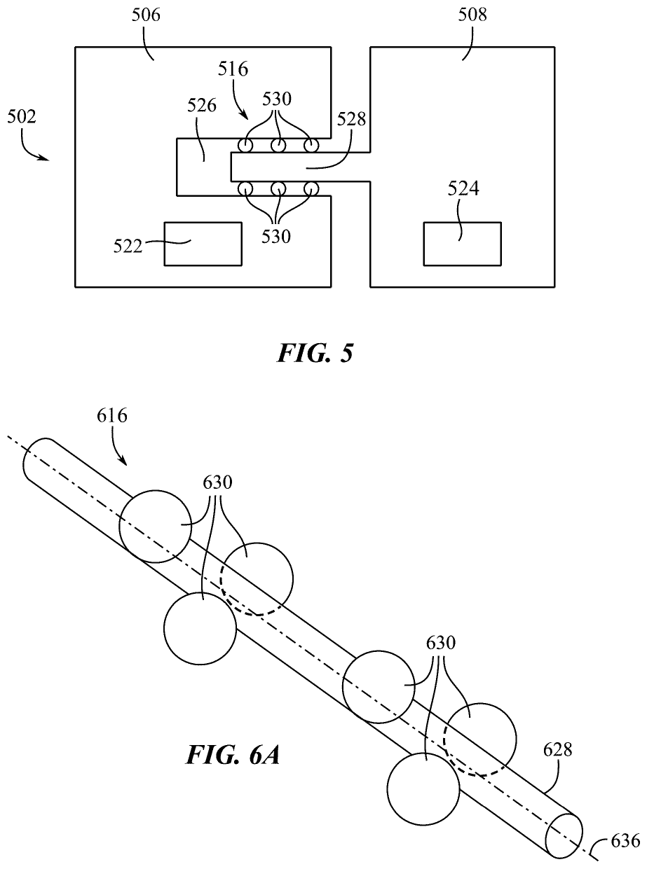

FIG. 5 illustrates a display portion 502 of a head-mountable display device including a first portion 506 and a second portion 508 slideably engaged with the first portion 506. In at least one example, the first portion can include a first component 522 and the second portion can include a second component 524. In one example, similar to the example shown in FIGS. 2 and 3, the first and the second components 522, 524 can include displays. Alternatively, in at least one example, the first component 522 can include a display and the second component 524 can include a lens, similar to the displays 410a,b and lenses 414a,b shown in the example of FIG. 4. The first and second portions 506, 508 of the display portion 502 can include housing portions or frame portions coupled to the first and second components 522, 524, respectively. The components 522, 524 can be coupled with or a part of the first and second portions 506, 508, respectively, such that the components 522, 524 are adjustable in position or angle relative to one another insofar as the first and second portions 506, 508 of the display portion 502 are adjustable in position relative to one another.

In one or more other examples, the first and second components 522, 524 can include any other components, including electronic component, of the display portion 502 of an electronic device. Other components can include any components where an adjustment therebetween affects or improves the performance or functionality of the components. Other examples include other visual components such as displays, lenses, sensors, lights, and so forth.

The display portion 502 can also include an adjustment mechanism 516. In at least one example, the adjustment mechanism 516 can include a bore 526 defined by the first portion 506 and a rod 528 extending in the bore 526. In addition, the adjustment mechanism 516 can include one or more roller bearings 530 disposed between the rod 528 and the first portion 506 within the bore 526. The rod 528 can extend from and/or be defined by the second portion 508 in the example shown in FIG. 5. Alternatively, in one or more examples, the second portion 508 can define a bore and a rod can extend from or be defined by the first portion 506.

The adjustment mechanism 516 enables relative movement and positioning between the first and second portions 506, 508 of the display portion 502 as the rod 528 moves in and out of the bore 526. The bearings 530 reduce friction associated with the relative movement. In at least one example, the bearings 530 are consistently in contact with the first portion 506 defining the bore 526 as well as the rod 528 such that during movement and after movement of the first portion 506 relative to the second portion 508, there is no slop due to space between the bearings 530 and the second portion 506 and/or the rod 528. In at least one example, the adjustment mechanism 516 includes a biasing member directly contacting the bearings 530 and pushing the bearings against the rod 528 at all times during and after adjustments are made by the user. In this way, the adjustment mechanism 516 is configured to alter a distance between the first and second components 522, 524, which as noted above can include first and second displays, or a display and a lens, and so forth.

Any of the features, components, and/or parts, including the arrangements and configurations thereof shown in FIG. 5 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 5.

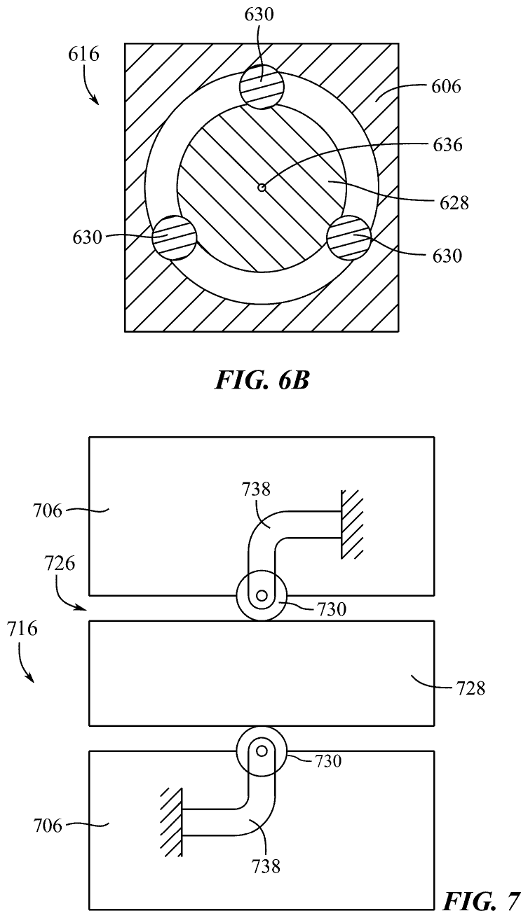

FIGS. 6A and B illustrate a perspective view and a front view, respectively, of a rod 628 and roller bearings 630 disposed against the rod 628 within a bore defined by a portion of a display device as part of an adjustment mechanism 616. The portion of the display device defining the bore within which the rod 628 and bearings 630 are disposed is not illustrated in FIG. 6A in order to visualize the rod 628 and bearings 630. As illustrated in FIG. 6A, the bearings 630 can be disposed around and against the rod 628 in such a way the bearings 630 limit the movement of the rod 628 to one degree of freedom along a longitudinal axis 636 of the rod 628. In one or more examples, the number, position, arrangement, shape, and size of the bearings 630 contacting the rod 628 can vary.

As seen in the front view of FIG. 6B, which includes a first portion 606 constraining the bearings 630 against the rod 628, an adjustment mechanism of a head-mountable display can include a first roller bearing 630, a second roller bearing 630, and a third roller bearing 630. The roller bearings 630 can constrain a movement of the rod 628 to one degree of freedom including along the longitudinal axis 636 of the rod 628.

Any of the features, components, and/or parts, including the arrangements and configurations thereof shown in FIGS. 6A-6B can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIGS. 6A-6B.

In the various examples of adjustment mechanisms described herein, the roller bearings can be in constant contact with the rod to reduce slop in the system. Pre-loading roller bearings is typically done to keep roller bearings against a rod in linear rod bearings. However, avoiding pre-loading can reduce wear on the bearings, the rod, and the portion defining the bore to increase longevity of the adjustment mechanism. Accordingly, the adjustment mechanisms described herein can include biasing members directly contacting the bearings and pushing the bearings against the rod. In this way, a minimal pre-loading force from the biasing member acting on the bearings can maintain contact between the bearings and the rod. In addition, the biasing member can be designed to provide just enough force against the bearings and thus between the bearings and the rod to balance the need for friction in the system such that the adjustable portions of the electronic device do not shift or move during normal use but also provide low enough friction to allow a user to easily move the rod relative to the bore.

Along these lines, FIG. 7 illustrates one or more biasing members 738 directly contacting the roller bearings 730 disposed within a bore 726 defined by a first portion 706. The bore 728 can be defined by and/or extended from a second portion not shown in FIG. 7. The biasing member 378 can be anchored to the first portion 706 as shown and push the bearings 730 toward the rod 728. In at least one example, the biasing member 738 can include an anchored flexure arm having a first end and a second end, the first end fixed to the first portion 706 defining the bore 726 and the second end coupled to the roller bearing 730. The second end of the flexure arm of the biasing member 738 can be rotatably coupled to an axle passing through ha bearing wheel, as shown in FIG. 7.

In at least one example, the anchored flexure arm of the biasing member 738 can be elastically deformed away from the rod 728 as a result of the bearing 730 pressed against the rod 728. As such, the elastic nature of the flexure arm of the biasing member 728 anchored to the first portion 706 results in a reactive force pressing against the bearing 730 toward the rod 728. In the example shown in FIG. 7, the biasing members 738 directly contact the bearings 730 without the need for any additional or intermediate parts. This can reduce complexity and costs for manufacturing as well as allowing each biasing member 738 to be tuned to each individual bearing 730 for precise control of the forces and friction within the adjustment mechanism 716.

In at least one example, the biasing member 738 can push the bearings 730 against the rod 728 to remove backlash and slop within the adjustment mechanism 716. In at least one example where the display portion of a head-mountable display weighs between about 40-60 grams, for example about 50 grams, a normal force between each of the bearings 730 and the rod 728 provided by the biasing member 738 can be between about 1-10 Newtons. In one example, the normal force can be between about 2-5 Newtons or between about 3-4 Newtons. These forces can provide enough friction in the adjustment mechanism 716 between the rod 728 and bearings 730 to prevent the rod 728 from shifting during normal use before and after being adjusted but also allow the user to easily adjust the position of the rod 728 within the bore 726. The normal force can be adjusted or designed to be greater or less than the forces noted above to accommodate a display portion of a head-mountable device that is heavier or lighter, respectively than that noted above.

Any of the features, components, and/or parts, including the arrangements and configurations thereof shown in FIG. 7 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 7.

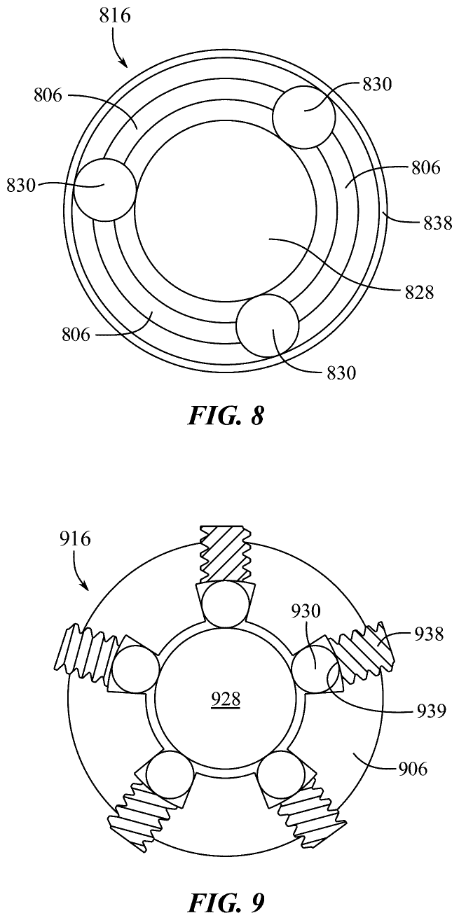

FIG. 8 illustrates another example of an adjustment mechanism including a bore defined by a first portion 806 and a rod 828 extending in the bore and defined by or extending from a second portion adjustable relative to the first portion 806. The adjustment mechanism 816 can include one or more bearings 830 and an elastic member 838 directly contacting the bearings 830 and pushing the bearings 830 against the rod 828, as shown. In at least one example, the biasing member 838 can include an elastic band or sheath. The band can extend around the rod 828. A sheath can extend around the rod and significantly along a longitudinal length of the rod 828. The elastic band of the biasing member 838 can extend around an outer periphery of the bore, and in some examples at least partially define the bore, and around an outer periphery of the plurality of bearings 830 disposed against the rod 828 and held in position by the first portion 806 defining the bore.

In at least one example, the elastic band of the biasing member 838 is elastically stretched material deformed to extend around and directly contact the bearings 830 such that an elastic returning force of the biasing member 838 pushes the bearings 830 toward and against the rod 828 as shown. In at least one example, the biasing member 838 includes a rubber band or sheath. In at least one example, the biasing member 838 includes a silicone band or sheath. For example, the biasing member 838 can include silicone doped with fluorine. The elastic band or sheath of the biasing member 838 can include a low friction material and/or a low friction coating on an inner surface of the biasing member 838 contacting the bearings 830.

In the example shown in FIG. 8, the biasing member 838 directly contact the bearings 830 without the need for any additional or intermediate parts. This can reduce complexity and costs for manufacturing as well as allowing for a single biasing member 838 to apply and distribute a force against the plurality of bearings 830 evenly and precisely for precise control of the forces and friction within the adjustment mechanism 816.

In the illustrated example of the adjustment mechanism 816 in FIG. 8, the biasing member 816 can extend around all the bearings 830 and apply a normal force against the rod 828, with each normal force different than the other. For example, the biasing member 838 can push a first bearing of the bearings 830 illustrated in FIG. 8 against the rod 828 in a first direction normal to an outer surface of the rod 828 and the biasing member 838 can push a second bearing of the second bearings 830 against the rod 828 in a second direction different than the first direction and normal to the outer surface of the rod 828.

Any of the features, components, and/or parts, including the arrangements and configurations thereof shown in FIG. 8 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 8.

FIG. 9 illustrates another example of an adjustment mechanism 916 including a first portion 906 defining a bore through which or in which a rod 928 extends. The first portion 906 can define features in which the bearings 930 are disposed to restrict the bearings 930 from moving circumferentially around the rod 928. In addition, the adjustment mechanism can include a biasing member 938 including a set screw disposed through the first portion 930 and including a terminal surface 939 directly contacting each bearing 930. The screws can be threadably engaged with complimentary threaded through-holes defined by the first portion 930 such that twisting the screws of the biasing members 938 one way or the other can adjust the pre-load force of the terminal surface 939 of the screw against the bearing 930. In this way, the pre-load force and consequently the normal force of each bearing 930 against the rod 928 can be tuned and adjusted as needed.

Any of the features, components, and/or parts, including the arrangements and configurations thereof shown in FIG. 9 can be included, cither alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 9.

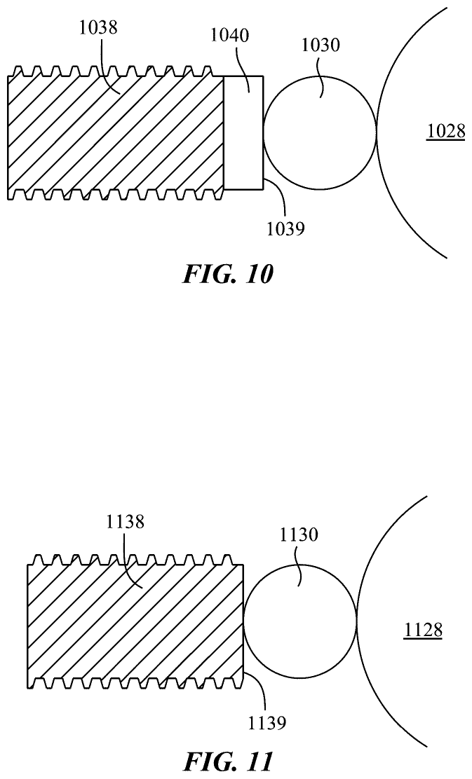

FIG. 10 illustrates and example of a screw 1038 pressing a bearing 1030 against a rod 1028. In the illustrated example, the screw 1038 can include an elastically compressible portion defining a terminal surface 1039 directly contacting the bearing 1030. In such an example, a minimal preload can be applied to the bearing 1030 and any movement of the rod 1028 toward and away from the bearing 1030 is absorbed by the elastically compressible portion 1040 such that the bearing 1030 maintains contact with the rod 1028 and backlash and slop is eliminated or reduced.

FIG. 11 illustrates another biasing member 1138 in the form of a set screw having a terminal surface 1139 directly contacting the bearing 1130 and pushing the bearing 1130 against a rod 1128. In the illustrated example, the biasing member 1138 can be a set screw formed of elastic material such that the set screw itself elastically deforms due to forces of the bearing 1130 and rod 1128 acting thereon.

Any of the features, components, and/or parts, including the arrangements and configurations thereof shown in FIGS. 10 and 11 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIGS. 10 and 11.

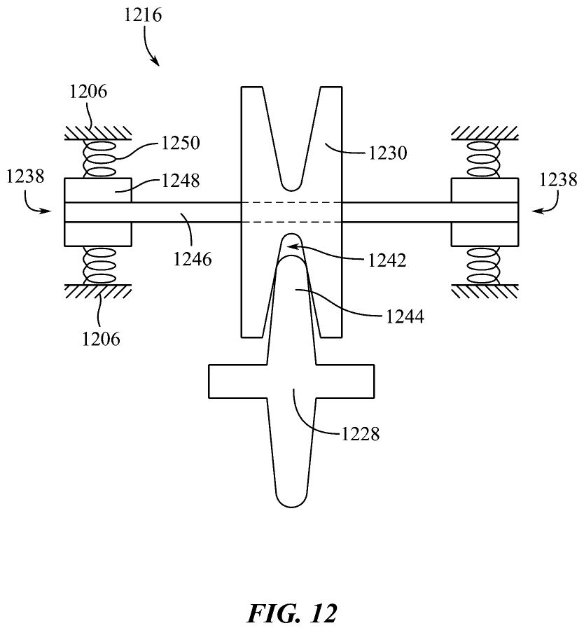

FIG. 12 illustrates another example of an adjustment mechanism 1216 including a track and rail configuration. The adjustment mechanism 1216 includes a bearing wheel 1230 defining a recessed or concave feature 1242 configured to mate with a complimentary protruding or convex track feature 1244 of a rod 1228. An axle 1246 passing through the bearing wheel 1230 can be restricted at either end via a biasing member or assembly 1238. The biasing assembly 1238 can include a first portion 1248 securing the ends of the axle 1246 and coupled to a first portion 1206 of a head-mountable display via a spring mechanism 1250. In this way, forces from the rod 1228 against the wheel bearing 1230, causing the bearing wheel 1230 to move during adjustment and articulation of the rod 1228 can be absorbed by the spring mechanism 1250 of the biasing assembly 1238 on either end of the axle 1246 to maintain contact between the bearing wheel 1230 and the rod 1228. In this way, the illustrated example of the adjustment mechanism 1216 can minimize slop and backlash during use, leading to precise adjustments for the user.

In at least one example, the rod 1228 can include features and cross-sectional geometry, including the protruding track feature 1244 shown in FIG. 12, to reduce total material weight of the rod 1228 while maintaining or increasing a stiffness of the rod 1228. In addition, due to the nature of the contact between the protruding track feature 1244 of the rod 1228 and the concave feature 1242 of the bearing wheel 1230, any lateral movement (i.e., left and right movement in the orientation of FIG. 12) of the bearing wheel 1230 relative to the rod 1228 is restricted or eliminated, further reducing slop and backlash within the adjustment mechanism 1216. As noted elsewhere with reference to rods in other examples, the rod 1228 shown in FIG. 12 can be defined by or extend form a second portion of a display portion of a head-mountable device, which is not shown in FIG. 12.

Any of the features, components, and/or parts, including the arrangements and configurations thereof shown in FIG. 12 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 12.

According to some examples, the present systems and methods may gather personal information data to implement and improve on the various embodiments described herein. If personal information data is gathered, it should be gathered pursuant to authorized and well established secure privacy policies and practices that are appropriate for the type of data collected. However, it will be understood that the present exemplary systems and methods are not, however, rendered inoperable in the absence of such personal information data.

It will be understood that many modifications and variations are possible in view of the above teachings and that the details of the present systems and methods above can be combined in various combinations and with alternative components. Additionally, the examples described herein are merely provided for illustration and description. The scope of the present exemplary systems and methods will be further understood by the following claims.

What is claimed is:

1. A head-mountable display, comprising:
a first portion including a display; and
a second portion slidably engaged with the first portion via an adjustment mechanism, the adjustment mechanism comprising:
a bore defined by the first portion or the second portion;
a rod extending in the bore;
a roller bearing; and
a biasing member contacting the roller bearing.

2. The head mountable display of claim 1, wherein:
the roller bearing is a first roller bearing;
the adjustment mechanism further comprises a second roller bearing and a third roller bearing; and
the first roller bearing, the second roller bearing, and the third roller bearing constrain a movement of the rod to one degree of freedom.

3. The head-mountable display of claim 1, wherein the biasing member comprises an elastic band.

4. The head-mountable display of claim 3, wherein the elastic band comprises silicone.

5. The head-mountable display of claim 3, wherein the elastic band defines the bore.

6. The head-mountable display of claim 1, wherein the biasing member includes a flexure arm having a first end and a second end, the first end anchored to the first or the second portion and the second end coupled to the roller bearing.

7. The head-mountable display of claim 1, wherein:
the display is a first display;
the second portion includes a second display; and
the adjustment mechanism is configured to alter a distance between the first display and the second display.

8. The head-mountable display of claim 1, wherein:
the second portion comprises a lens; and
the adjustment mechanism is configured to alter a distance between the display and the lens.

9. An adjustment mechanism for a head-mountable device, comprising:
a bore defined by a first portion, the first portion including a first display;
a rod extending from a second portion and into the bore, the second portion including a second display;
a bearing disposed against the rod; and
a biasing member contacting the bearing.

10. The adjustment mechanism of claim 9, wherein:
the first display includes a first pupillary alignment point; and
the second display includes a second pupillary alignment point.

11. The adjustment mechanism of claim 10, wherein sliding the rod relative to the bore alters a distance between the first pupillary alignment point and the second pupillary alignment point.

12. The adjustment mechanism of claim 9, wherein the biasing member pushes the bearing toward the rod.

13. The adjustment mechanism of claim 12, wherein the biasing member is anchored to the first portion.

14. The adjustment mechanism of claim 12, wherein the biasing member comprises an elastically stretched material disposed around the rod and the bearing, the bearing disposed between the biasing member and the rod.

15. The adjustment mechanism of claim 12, wherein the biasing member comprises a set screw having a terminal surface contacting the bearing.

16. The adjustment mechanism of claim 15, wherein the set screw comprises an elastic material.

17. A rod bearing assembly, comprising:
a first portion defining a bore;
a rod extending in the bore;
a roller bearing; and
a biasing member contacting the roller bearing and pushing the roller bearing toward the rod.

18. The rod bearing assembly of claim 17, wherein:
the roller bearing comprises a first roller bearing;
the rod bearing assembly comprises a second roller bearing; and
the biasing member contacts the second bearing.

19. The rod bearing assembly of claim 18, wherein the biasing member includes an elastic band or sheath.

20. The rod bearing assembly of claim 19, wherein:
the biasing member elastically deforms and is disposed around the rod;
the first roller bearing and the second roller bearing are positioned between the biasing member and the rod;
the biasing member pushes the first roller bearing against the rod in a first direction normal to an outer surface of the rod; and
the biasing member pushes the second bearing against the rod in a second direction different than the first direction and normal to the outer surface of the rod.
